(19) United States
(12) Patent Application Publication
(10) Pub. No.: US 2008/0040814 A1
(43) Pub. Date: Feb. 14, 2008

(54) Method for Using a Contents Software

(75) Inventors: Akihiro Kasahara, Chiba-ken (JP); Akira Miura, Kanagawa-ken (JP); Hiroshi Suu, Kanagawa-ken (JP); Kazunori Nakano, Tokyo (JP); Shigeru Ishida, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, MINATO-KU (JP)

(21) Appl. No.: 11/572,466

(22) PCT Filed: Jun. 22, 2005
(86) PCT No.: PCT/JP05/11880

§ 371 Date: Apr. 19, 2007

(30) Foreign Application Priority Data
Jul. 23, 2004 (JP) 2004-216326

(51) Int. Cl. G06F 21/00

(52) U.S. Cl. 726/28

(57) ABSTRACT

A key memory medium stores a medium identifier, a medium inherent key based on the medium identifier, an encrypted user key of a user key based on the medium inherent key, and an encrypted contents key of a contents key based on the user key. A contents memory medium stores an encrypted contents software of the contents software based on the contents key. A start-up software of the contents software is executed. The medium inherent key is generated using the medium identifier. The user key is derived from the encrypted user key using the medium inherent key. The contents key is derived from the encrypted contents key using the user key. The contents software is derived from the encrypted contents using the contents key.

### TECHNICAL FIELD

The present invention relates to a method for using a contents software encrypted by a double key method.

### BACKGROUND ART

In recent years, in proportion to development of informational society, a contents marketing system is widely used. In the contents marketing system, contents (such as an electronic book, newspaper, music, dynamic image, or game) are distributed to a user terminal, and the contents can be inspected (watch or listen) by a user.

In this kind of the contents marketing system, in order to prevent illegal copy, a contents protection technique is used. In the contents protection technique, contents are encrypted by an encryption key, encrypted contents are delivered or circulated, and the encrypted contents are decrypted in case of reproducing. As the contents protection technique, CPPM (Content Protection for Prerecorded Media) is well known. For example, known contents protection techniques include, for example, SD-Audio or SD-ePublish (4C Entity, LLC, [online], Internet <URL:http://www.4Centity.com/>)

Recently, as a protection technique based on CPPM, encryption double key method uses a contents key (title key) doubly encrypted by a user key and a media inherent key. This technique is disclosed in International Application No. PCT/JP03/11477 (International Publication No. WO 2004/036434 A1). For example, the encryption double key method is used for MQbic (registered trademark).

FIG. 1 is a block diagram of a SD card 10 and a user terminal 20 applied to the encryption double key method. The SD card is one example of a secure memory device in which data is securely stored. The SD card comprises a system area 1, a hidden area 2, a protected area 3, a user data area 4, and an encryption/decryption unit 5. Data are stored in each area 1˜4 in correspondence with the SD audio standard.

Concretely, the system area 1 stores a key management data MKB (Media Key Block) and a media identifier IDm. The hidden area 2 stores a media inherent key Kmu. The protected area 3 stores an encrypted user key Enc (Kmu, Ku). The user data area 4 stores an encrypted contents key Enc (Ku, Kc). In this case, “Enc (A, B)” represents data B encrypted by data A.

The system area 1 is an area accessible (read only area) from the outside of the SD card 10. The hidden area 2 is a reference area (read only area) of the SD card and is non-accessible from the outside. The protected area is an area readable/writable from the outside in case of a successful confirmation. The user data area 4 is readable/writable freely from the outside. The encryption/decryption unit 5 executes a confirmation, a key exchange, and an encryption processing between the protected area and the outside of the SD card. Furthermore, the encryption/decryption unit 5 includes an encryption/decryption function.

As for the SD card 10, the user terminal 20 (used for reproduction) logically operates as follows. In the user terminal 20, first, the key management data MKB is read from the system area 1 of the SD card 10, and the key management data MKB is MKB-processed using a device key Kd (preset in the user terminal 20) (ST1). As a result, a media key Km is obtained. Next, in the user terminal 20, the media identifier IDm is read from the system area 1 of the SD card 10, and the media identifier IDm and the media key Km are hash-processed (ST2). As a result, a media inherent key Kmu is obtained.

Next, in the user terminal 20, confirmation and key exchange (AKE: Authentication Key Exchange) are executed using the media inherent key Kmu with the encryption/decryption unit 5 of the SD card (ST3). As a result, a session key Ks is shared between the SD card 10 and the user terminal 20. Concretely, in case of coinciding the media inherent key Kmu stored in the hidden area 2 of the SD card 10 with the media inherent key Kmu generated in the user terminal 20, the confirmation and key exchange processing (ST3) are successful, and the session key Ks is shared.

Next, in the user terminal 20, the encrypted user key Enc (Kmu, Ku) is read from the protected area 3 by encryption communication using the session key Ks (ST4). The encrypted user key Enc (Kmu, Ku) is decrypted using the media inherent key Kmu (ST5). As a result, a user key Ku is obtained.

Next, in the user terminal 20, the encrypted contents key Enc (Ku, Kc) is read from the user data area 4 of the SD card 10, and the encrypted contents key Enc (Ku, Kc) is decrypted using the user key Ku (ST6). As a result, a contents key Kc is obtained.

Last, in the user terminal 20, an encrypted contents Enc (Kc, C) is read from a memory medium 21, and the encrypted contents Enc (Kc, C) is decrypted using the contents key Kc (ST7). As a result, contents software C is reproduced.

However, the encryption double key method is not applicable to the contents software in need of a start-up software to start the contents software, such as a game software for a personal computer.

On the other hand, it is considered that the game software for the personal computer will be widely utilized in the future. Accordingly, it is desired that the contents software needing the activation software can be used with the encryption double key method.

### DISCLOSURE OF INVENTION

The present invention is directed to a method for using a contents software encrypted by the double key method even if the contents software needs a start-up software.

According to an aspect of the present invention, there is provided a method for using a contents software in a user terminal having a key memory medium and a contents memory medium, the key memory medium storing a medium identifier, a medium inherent key based on the medium identifier, an encrypted user key of a user key based on the medium inherent key, and an encrypted contents key of a contents key based on the user key, and the contents memory medium storing an encrypted contents software of the contents software based on the contents key, the method comprising: executing a start-up software of the contents software; generating the medium inherent key using the medium identifier; deriving the user key by decrypting the encrypted user key using the medium inherent key; deriving the contents key by decrypting the encrypted contents key using the user key; and deriving the contents software by decrypting the encrypted contents software using the contents key.

According to another aspect of the present invention, there is also provided a computer program product, comprising: a computer readable program code embodied in said product for causing a computer to use a contents software in a user terminal having a key memory medium and a contents memory medium, the key memory medium storing a medium identifier, a medium inherent key based on the medium identifier, an encrypted user key of a user key based on the medium inherent key, and an encrypted contents key of a contents key based on the user key, and the contents memory medium storing an encrypted contents software of the contents software based on the contents key, said computer readable program code comprising: a first program code to execute a start-up software of the contents software; a second program code to generate the medium inherent key using the medium identifier; a third program code to derive the user key by decrypting the encrypted user key using the medium inherent key; a fourth program code to derive the contents key by decrypting the encrypted contents key using the user key; and a fifth program code to derive the contents software by decrypting the encrypted contents software using the contents key.

This patent application is based upon and claims the benefit of priority from the Japanese Patent Application No. 2004-216326, filed on Jul. 23, 2004, the entire contents of which are incorporated herein by reference.

### BRIEF DESCRIPTION OF DRAWINGS

A more complete appreciation of the present invention and many of the attendant advantages thereof will be readily obtained as the same becomes better understood by reference to the following detailed descriptions when considered in connection with the accompanying drawings, wherein:

FIG. 1 is a block diagram of a SD card and a user terminal of the encryption double key method according to the prior art.

FIG. 2 is a block diagram of a system applied to the contents use system according to a first embodiment;

FIG. 3 is a schematic diagram of a holder of the SD card according to the first embodiment;

FIG. 4 is a flow chart of the contents use method according to the first embodiment;

FIG. 5 is a block diagram of a system applied to the contents use system according to a second embodiment;

FIG. 6 is a schematic diagram of one example of a license center apparatus according to the second embodiment;

FIG. 7 is a flow chart of the contents use method according to the second embodiment;

FIG. 8 is a schematic diagram of data flow in the contents use system according to the second embodiment;

FIG. 9 is a schematic diagram of one example of charge flow in the contents use system according to the second embodiment;

FIG. 10 is a block diagram of a system applied to the contents use system according to a third embodiment;

FIG. 11 is a flow chart of the contents use method according to the third embodiment;

FIG. 12 is a block diagram of a system applied to the contents use system according to a fourth embodiment; and

FIG. 13 is a flow chart of the contents use method according to the fourth embodiment.

### BEST MODE FOR CARRYING OUT THE INVENTION

An embodiment of the present invention will be explained below with reference to the drawings. The same or similar components are indicated by the same reference numerals throughout the drawings and redundant explanations about them are omitted.

### INDUSTRIAL APPLICABILITY

Hereinafter, various embodiments of the present invention are explained by referring to the drawings. In following each embodiment, a start-up software to start the contents software is executed, but a place to store the start-up software is different. Briefly, in the first embodiment, the start-up software is previously installed into the user terminal. In the second embodiment, the start-up software is previously stored in an external memory medium such as a CD or a DVD. In the third embodiment, the start-up software is previously stored in an external memory medium such as a hard disk. In the fourth embodiment, the start-up software is previously stored in the SD card.

### The First Embodiment

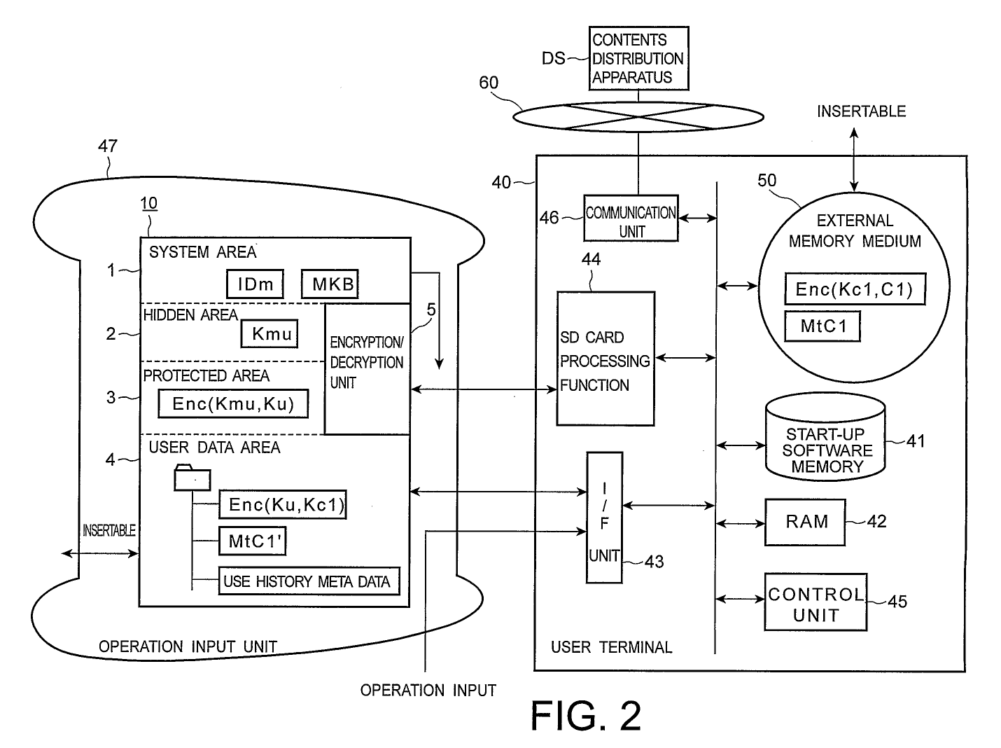

FIG. 2 is a block diagram of a system applied to the contents use method according to the first embodiment. In this system, a user terminal 40 insertably holds the SD card 10 through an operation input unit 47. The user terminal 40 insertably holds an external memory medium 50 such as a CD or a DVD. In this case, “insertably” means free insertion/removal, and represents one form of attachment (free attachment/detachment). Furthermore, the user terminal 40 can communicate with a contents distribution apparatus DS through a network 60.

The SD card 10 comprises areas 1˜4 and the encryption/decryption unit 5 (explained before). The system area 1 stores a key management data MKB and a media identifier IDm. The hidden area 2 stores a media inherent key Kmu. The protected area 3 stores an encrypted user key Enc (Kmu, Ku). The user data area 4 stores an encrypted contents key Enc (Ku, Kc1), meta data MtC1′, and use history meta data of all contents.

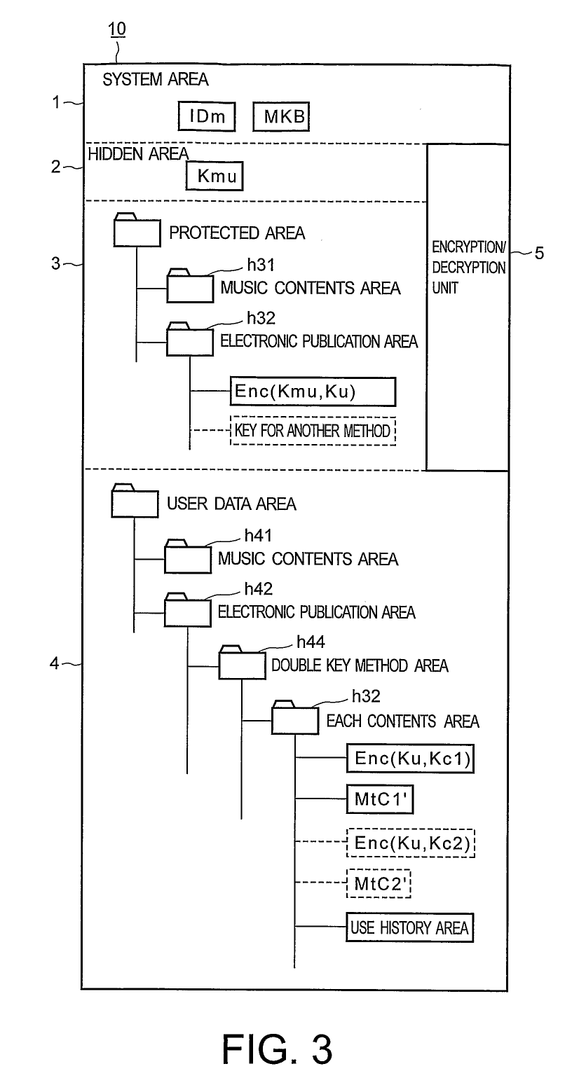

In the protected area 3 shown in FIG. 3, a music contents area and an electronic publication area are respectively classified by folders h31 and h32. In a lower level area of a folder h32 of the electronic publication area, an encrypted user key Enc (Kmu, ku) is stored.

In the user data area 4 shown in FIG. 3, a music contents area and an electronic publication area are respectively classified by folders h41 and h42. In a lower level area of a folder h42 of the electronic publication area, a double key method area is classified by a folder h43. In a lower level area of a folder h43 of the double key method area, each contents area is classified by a folder h44. In a lower level area of the folder h44, an encrypted contents key Enc (Ku, Kc1) of contents C1, meta data MtC1′ of the contents C1, and use history meta data of all contents, are stored. In case of storing an encrypted contents key and meta data of another contents C2, these are newly stored in a lower level area of the folder h44 of each contents area.

The meta data MtC1′ of contents C1 is not a perfect meta data of contents C1 but correspondence data between the contents C1 and the encrypted contents key Emc (Ku, Kc1). For example, a title (contents name) and a contents ID may be included. Furthermore, progress data to execute the next processing from a completion timing of previous processing may be included.

On the other hand, the use history meta data of all contents represents a use history of each contents in the SD card. For example, an execution data and an execution time of each contents ID may be included. Furthermore, a use frequency of each contents ID may be included.

In the user terminal 40 shown in FIG. 2, a start-up software memory 41, a RAM 42, an I/F unit 43, a SD card processing function 44, a control unit 45, a communication unit 46, and an external memory medium 50, are connected together via a bus. Furthermore, an operation input unit 47 is externally connected through the I/F unit 43. If the user terminal 40 includes the SD card processing function 44 and an ordinary computer function, an arbitrary device such as a personal computer or a portable information terminal (PDA) is usable.

The start-up software memory 41 is a memory area into which a start-up software to start a contents software C1 is previously installed. The start-up software is readable from/writable into the start-up software memory 41 by the control unit via the bus.

The RAM 42 is a readable/writable memory by the control unit 45. For example, in case that the control unit 45 executes the start-up software, the start-up software read from the start-up software memory 41 is stored.

The I/F unit 43 includes an interface function between the operation input unit 47 and the user terminal 40. In order to simplify the explanation, description of the I/F unit 43 between the operation input unit 47 and the user terminal 40 is omitted.

The SD card processing function 44 is controlled by the control unit 45, and includes a confirmation function and an encryption communication function with the SD card 10, and read/write function of memory contents of each area 1, 3, 4. The SD card processing function 44 can be realized by a software component, or a combination of a software component and a hardware component. The software component can be realized by installation of a program to execute the function 44 into a computer of the user terminal 40.

The control unit 45 includes an ordinary computer function, a function to control each unit 41˜46 based on a user's operation, and a function to read the encrypted contents Enc (Kc1, C1) and the meta data MtC1 from the external memory medium 50.

The communication unit 46 is controlled by the control unit 45, and includes a function to download the encrypted contents Enc (Kc1, C1) from a contents distribution apparatus DS. For example, a browser is usable.

The operation input unit 47 is, for example, a game controller of a home game machine holding the SD card. The operation input unit 47 includes a function to send an input signal of the user's operation to the user terminal 40, and an interface function between the SD card 10 and the user terminal 40.

The external memory medium 50 is a memory medium readable by the user terminal 40, and stores the encrypted contents Enc (Kc1, C1) and the meta data MtC1 of contents C1. The meta data MtC1 (stored with the encrypted contents in the external memory medium 50) is different from meta data MtC1′ (stored with the encrypted contents key in the SD card 10), and represents a complete meta data MtC1 of contents Cl. This meta data includes static meta data (such as a contents ID, a revision, a title, and a creator's name) and a dynamic meta data (such as sales resource data (ID of the contents distribution apparatus DS) and charge data (purchase step and sales price of the contents key)). As the external memory medium 50, an optical disk such as a CD or a DVD insertable into the user terminal 40 is shown in FIG. 2. However, it may be a hard disk stored in or connected to the user terminal 40.

The contents distribution apparatus DS includes a function to send the encrypted contents Enc (Kc1, C1) and the meta data MtC1 to the user terminal 40 in response to a download request from the user terminal 40.

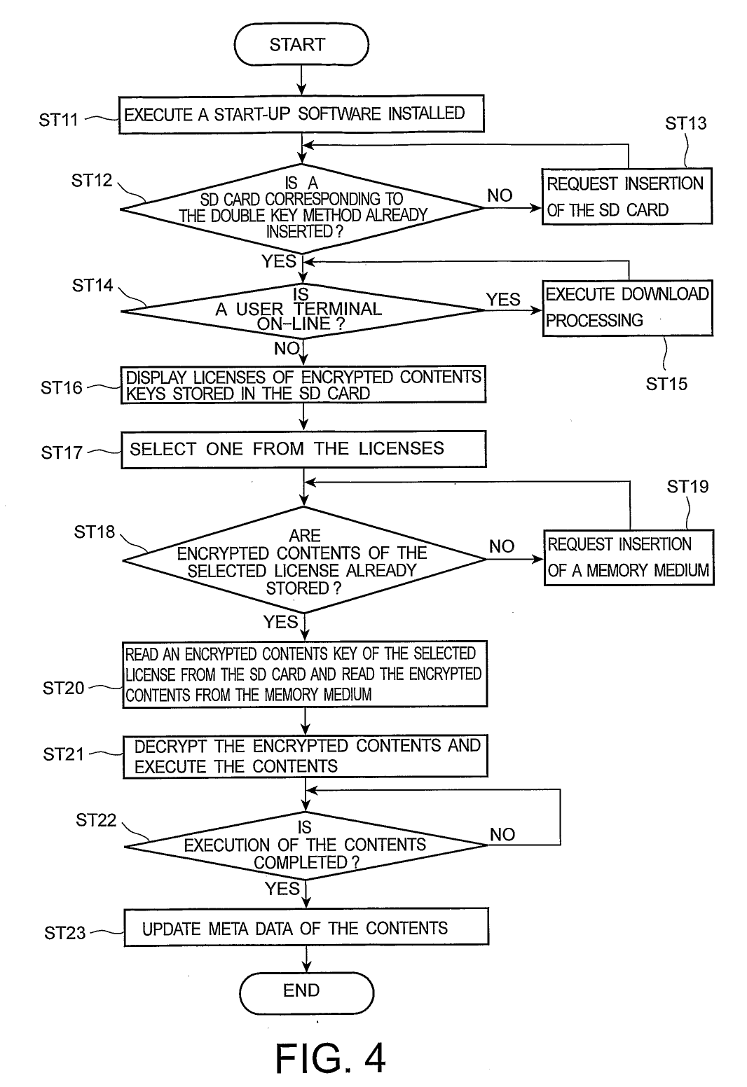

Next, the contents use method of the system in FIG. 2 is explained by referring to a flowchart of FIG. 4.

In the user terminal 40, execution of the start-up software is indicated by a user's operation through a keyboard (not shown in FIG. 2). The control unit 45 in the user terminal 40 reads the start-up software (already installed) from the start-up software memory 41 to the RAM 42, and executes the start-up software (ST11).

The control unit 45 searches a SD card corresponding to the encryption double key method based on the start-up software, and decides whether the SD card 10 is already inserted (exists) into the operation input unit 47 (ST12). If the SD card is not inserted yet, the control unit 45 requests insertion of the SD card by outputting a message through a display unit (not shown in FIG. 2).

On the other hand, if the SD card is already inserted and if an encrypted contents is necessary to be obtained by on-line (ST14; Yes), the control unit 45 executes download processing through the communication unit 46, and downloads the encrypted contents from the contents distribution apparatus DS (ST15).

If encrypted contents is not needed (ST14; No), the control unit 45 displays licenses (of encrypted contents keys) stored in the SD card through a display unit (not shown in FIG. 2) of the user terminal 40 by referring to the use history meta data in the SD card (ST16). The licenses represent contents executable by the encrypted contents key. Concretely, a title of the contents is displayed. As a display method, for example, an order of licenses, an order of use frequency, or an order of alphabet of titles can be applied.

In the user terminal 40, when one license is selected from the licenses displayed by the user's operation (ST17), meta data MtC1 (of contents C1) corresponding to the one license is searched using a contents ID of the one license, and it is decided whether the encrypted contents (of contents C1) is already stored in the memory medium based on existence of the meta data MtC1 (ST18).

If it is decided that the encrypted contents (of contents C1) is not stored yet (ST18; No), insertion of the memory medium storing the encrypted contents is requested by outputting a message through a display unit (ST19).

On the other hand, if it is decided that the encrypted contents is already stored in the memory medium (ST18; Yes), the control unit 45 reads the encrypted contents key Enc (Ku, Kc1) from the SD card through the SD card processing function 44, and reads the encrypted contents Enc (Kc1, C1) from the external memory medium 50 through the bus (ST20).

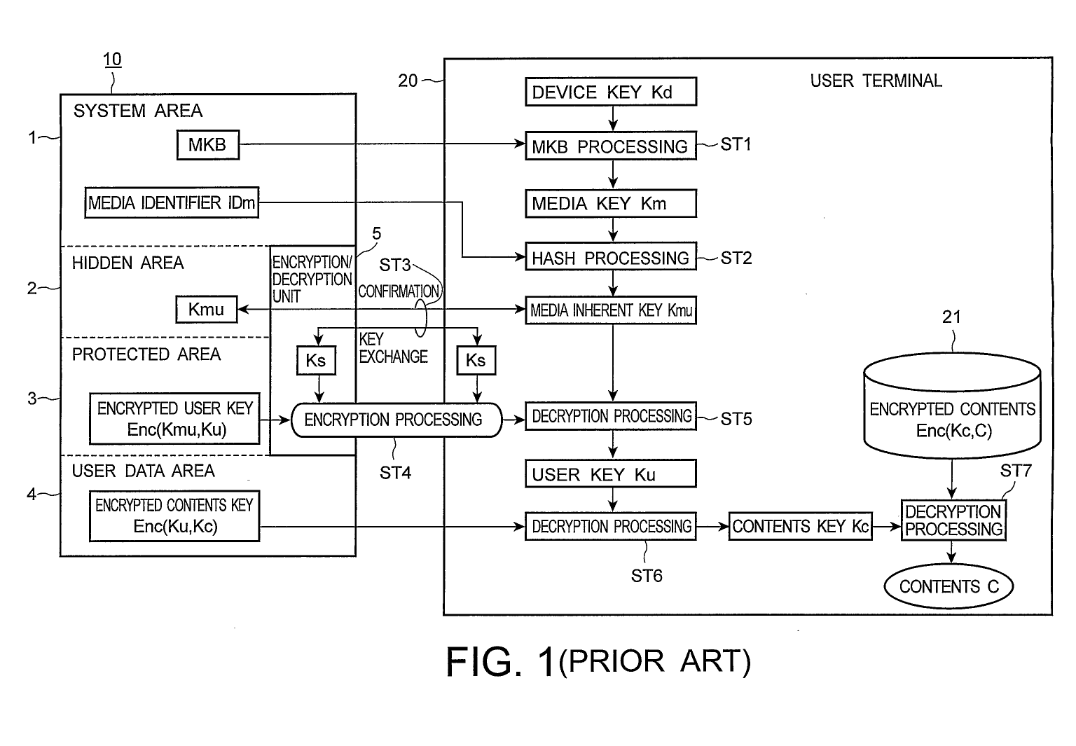

In this case, a method for obtaining a contents key Kc1 is same as steps ST1˜ST6 explained before. As shown in FIG. 1, the SD card processing function 44 executes MKB-processing of key management data MKB (read from the system area 1 of the SD card 10) using a preset device key Kd (ST1), and generates a media key Km. Next, the SD card processing function 44 executes hash-processing of the media key Km using a media identifier IDm (read from the system area 1 of the SD card 10) (ST2), and generates a media inherent key Kmu.

Then, the SD card processing function 44 executes confirmation/key exchange processing with the encryption/decryption unit 5 of the SD card 10 using the media inherent key Kmu (ST3), and shares a session key Ks with the SD card 10. Furthermore, the SD card processing function 44 reads an encrypted user key Enc (Kmu, Ku) from the protected area 3 through encryption communication using the session key Ks (ST4), decrypts the encrypted user key Enc (Kmu, Ku) using the media inherent key Kmu (ST5), and generates a user key Ku.

Furthermore, the SD card processing function 44 reads an encrypted contents key Enc (Ku, Kc1) from the user data area 4, decrypts the encrypted contents key Enc (Ku, Kc1) using the user key Ku (ST6), and generates a contents key Kc1.

Next, by executing the start-up software, the control unit 45 decrypts the encrypted contents Enc (Kc1, C1) using the contents key Kc1, and generates a contents software C1. As a result, the contents software is executable.

The user terminal 40 may set the contents software C1 as either an execution status or a holding status. In the same way, the user terminal 40 may set the start-up software as either a completion status or a waiting status. Hereinafter, an execution example of the contents software C1 is explained.

In the user terminal 40, execution of the contents software C1 (decrypted) is indicated (ST21). Then, in the user terminal 40, the start-up software is completed and the contents software C1 is executed. In this case, the start-up software is not always necessary to be completed. For example, the contents software C1 may be executed while the start-up software is under a waiting status. This is same in each embodiment explained afterwards.

Hereinafter, the user terminal 40 executes the contents software C1 until completion of contents is indicated (ST22; No).

In the user terminal 40, in response to an indication of contents completion (ST22; Yes), the meta data MtC1′ and the use history meta data of contents C1 in the SD card 10 are updated (ST23), and the contents software C1 is completed.

As mentioned-above, in the first embodiment, in the user terminal 40 installing the start-up software, by executing the start-up software indicated from the outside, the user terminal 40 decrypts the encrypted contents Enc (Kc1, C1) using the SD card 10, and generates the contents software Cl. Then, the user terminal 40 completes the start-up software, and executes the contents software C1. In this way, even if the contents software C1 needs the start-up software, the contents software C1 can be utilized by the encryption double key method.

### The Second Embodiment

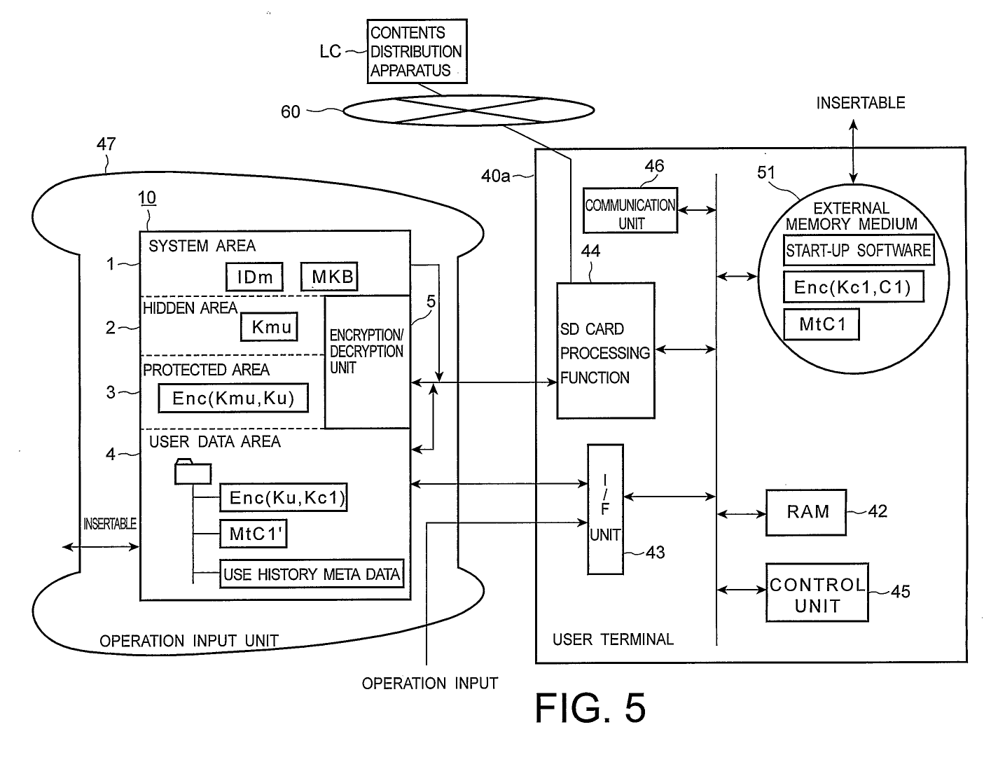

FIG. 5 is a block diagram of a system applied to the contents use method according to the second embodiment. As for the same part (unit) as in FIG. 2, the same number is assigned and the explanation is omitted. Hereinafter, processing of different parts is mainly explained.

The second embodiment is a modification example of the first embodiment, and a part to store the start-up software is different from the first embodiment. In the first embodiment, the start-up software is previously installed into the user terminal 40. However, in the second embodiment, the start-up software is stored in the external memory medium 51. The external memory medium 51 stores the start-up software in addition to memory content of the external memory medium 50 in FIG. 2.

In comparison with the user terminal 40 in FIG. 2, the start-up software memory 41 is omitted in a user terminal 40a as shown in FIG. 5. The user terminal 40a includes a function to detect insertion of the external memory medium 51 and a function to execute the start-up software stored in the external memory medium 51 by detecting the insertion.

In case of executing the start-up software, an encrypted contents is already stored in the external memory medium 51. In other words, the encrypted contents is not downloaded from the contents distribution apparatus DS. Accordingly, the contents distribution apparatus DS is omitted in FIG. 5. However, the user terminal 40a often accesses a license center apparatus LC in order to obtain an encrypted contents key. Accordingly, the license center apparatus LC is included in FIG. 5.

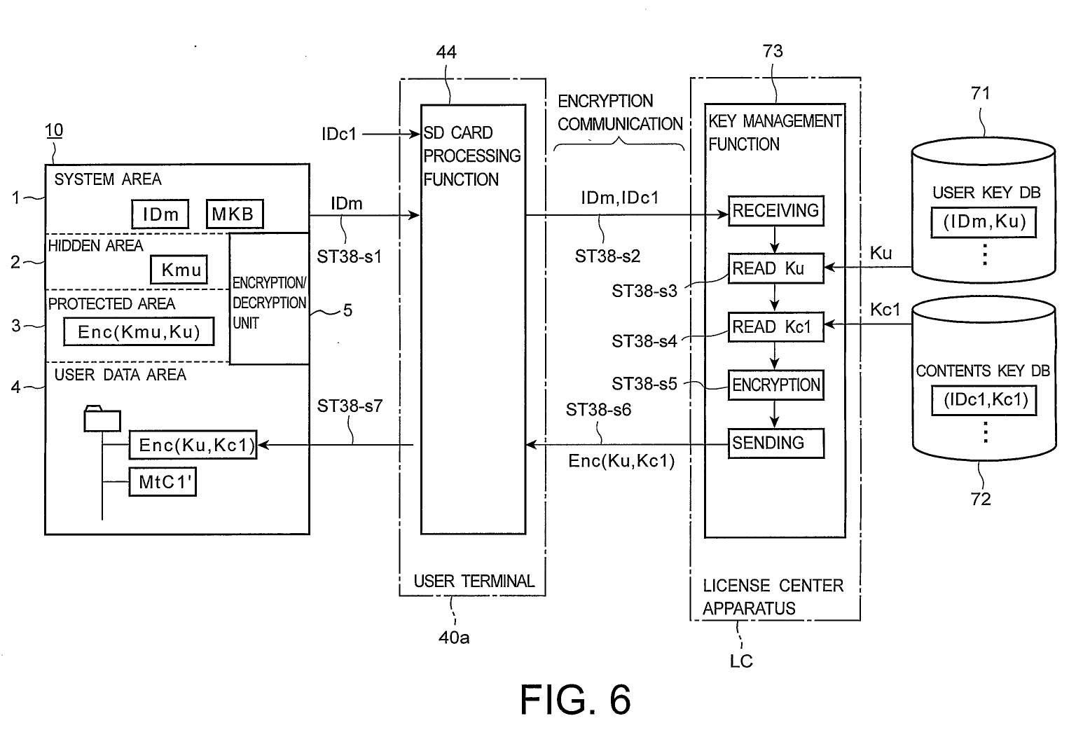

As shown in FIG. 6, the license center apparatus LC includes a user key DB (database) 71, a contents key DB (database) 72, and a key management function 73.

The user DB 71 stores a user key Ku of each media identifier IDm inherent to the SD card 10. The user key Ku is readable/writable by the key management function 73.

The contents key DB 72 stores a contents key Kc (For example, Kc1) of each contents identifier IDc (For example, Idc1) inherent to contents C. The contents key Kc is readable/writable by the key management function 73.

In response to a key sending request (including the contents identifier Idc1 and the media identifier IDm) from the user terminal 40a, the key management function 73 refers to each DB 71 and 72, and sends the encrypted contents key Enc (Ku, Kc1) and the meta data MtC1′ to the user terminal 40a.

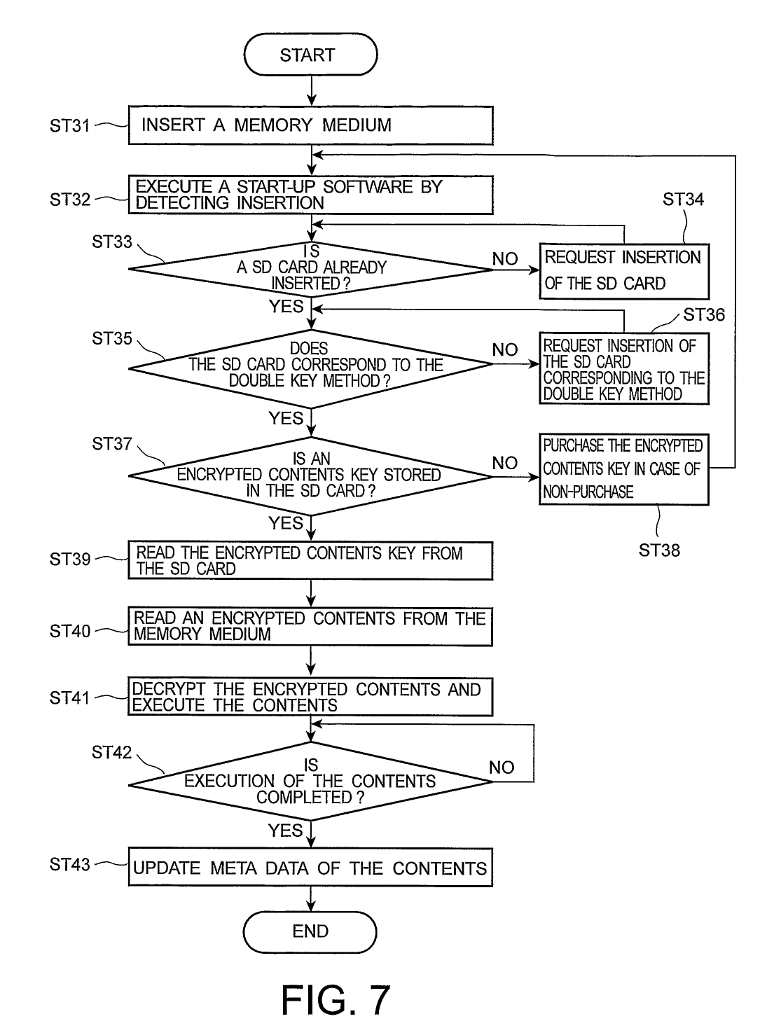

Next, the contents use method of the system in FIG. 5 is explained by referring to a flow chart of FIG. 7.

In the user terminal 40a, the external memory medium 51 is inserted by a user's operation (ST31). After detecting insertion of the external memory medium 51, the user terminal 40a reads the start-up software from the external memory medium 51 to the RAM 42, and executes the start-up software stored in the RAM 42 (ST32).

Based on the start-up software, the control unit 45 decides whether a SD card is already inserted by searching the SD card in the operation input unit 47 (ST33). If the SD card is not inserted yet, the control unit 45 requests insertion of the SD card by outputting a message through a display unit (ST34).

On the other hand, if the SD card is already inserted, the control unit 45 decides whether the SD card is a SD card corresponding to the encryption double key method (ST35). If the SD card is not a SD card corresponding to the encryption double key method, the control unit 45 requests insertion of the SD card corresponding to the encryption double key method by outputting a message through a display unit (ST36).

If the SD card is a SD card corresponding to the encryption double key method, the control unit 45 searches meta data MtC1′ stored in the SD card 10 using a contents ID included in the meta data MtC1 of the encrypted contents in the external memory medium 51. Briefly, the control unit 45 decides whether the encrypted contents key Enc (Ku, Kc1) corresponding to the contents ID is stored in the SD card 10 (ST37).

If the encrypted contents key Enc (Ku, Kc1) is not stored yet, the control unit 45 requests purchase of the encrypted contents key by outputting a message through the display unit (ST38).

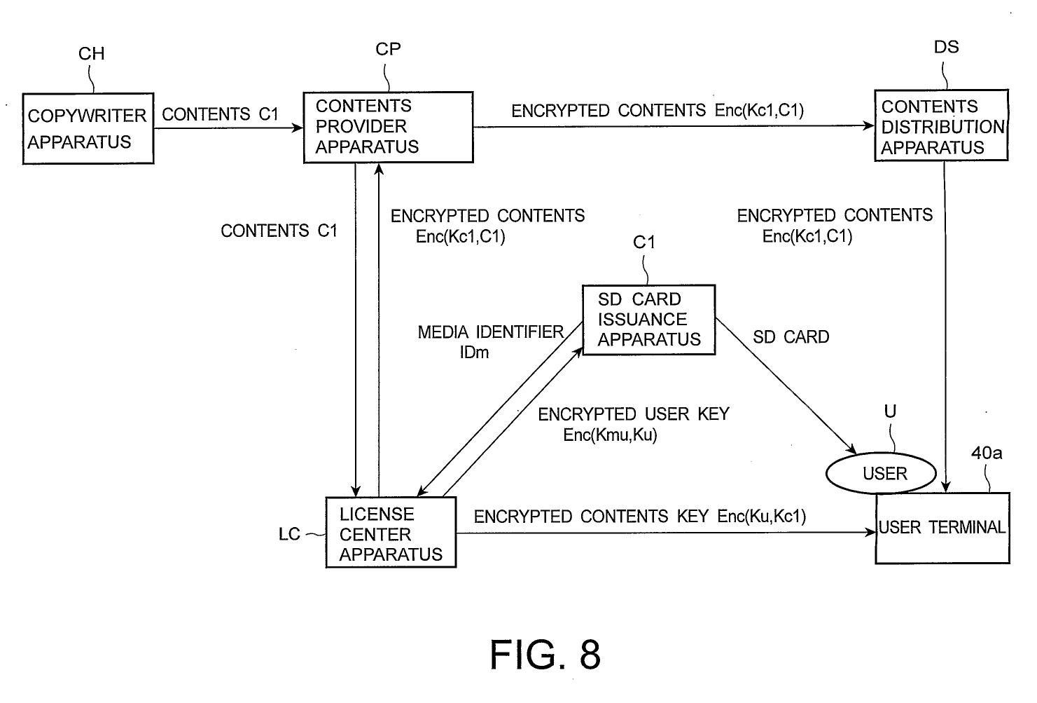

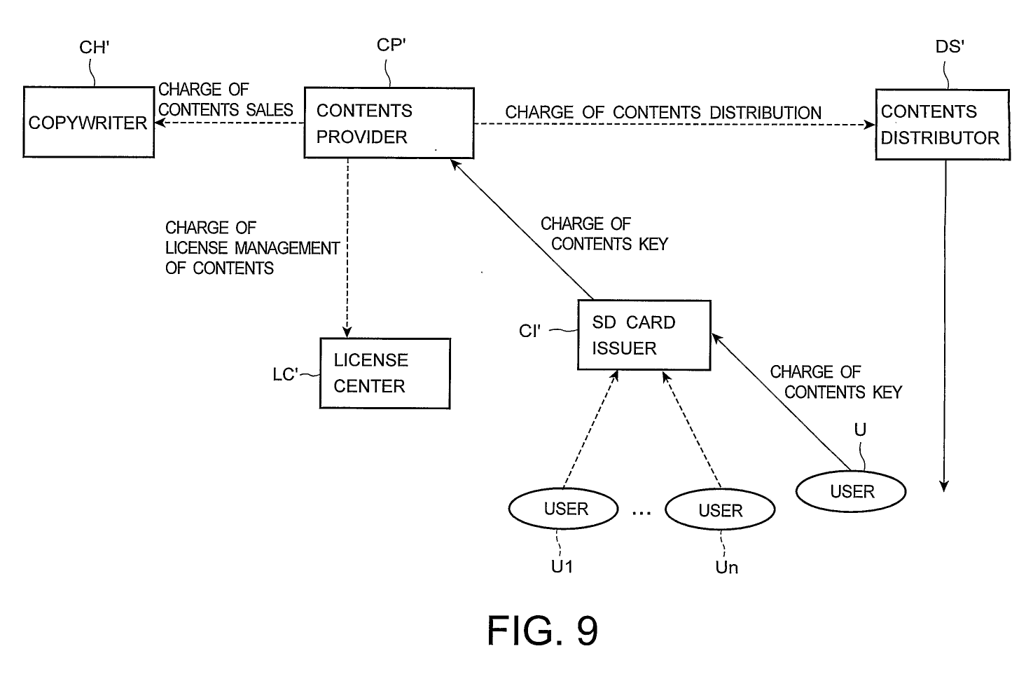

In this case, as shown in FIG. 8, the encrypted contents key is obtained from the license center apparatus LC for generating encrypted contents and an encrypted contents key. However, before obtaining the encrypted contents key, as shown in FIG. 9, it is necessary to settle a price of the encrypted contents key for an SD card issuer CI′ entrusted by the license center apparatus LC. Because the license center apparatus LC does not manage user's personal data (address, name, and so on), but the SD card issuer CI′ manages the user's personal data. A flow of price (charge) in FIG. 9 is one example. It is needless to say that the user's settlement processing may be executed by an arbitrary facility (For example, banking facilities, credit card) managing the user's personal data.

Next, after settling the encrypted contents key, steps to obtain the encrypted contents key are explained. As shown in FIG. 6, in the user terminal 40a, an identifier Idc1 of contents C1 is input to the SD card processing function 44, and the SD card processing function 44 reads the media identifier IDm from the SD card 10 (ST30-s1).

The SD card processing function 44 sends a key sending request (including the contents identifier Idc1 and the media identifier IDm) to the license center apparatus LC (ST38-s2). In this case, communication between the user terminal 40a and the license center apparatus LC is protected by encryption communication such as SSL.

In the license center apparatus LC, a key management function 73 reads a user key Ku corresponding to the media identifier IDm from the user key DB 71 (ST38-s3), and reads a contents key Kc1 and meta data MtC1′ each corresponding to the contents identifier Idc1 from the contents key DB 72 (ST38-s4).

Then, the key management function 73 encrypts the contents key Kc1 using the user key Ku (ST38-s5), and sends an encrypted contents key Enc (Ku, Kc1) and meta data MtC1′ of plain text (a purchase date and a purchase number are added) to the user terminal 40a (ST38-s6).

In the user terminal 40a, the SD card processing function 44 writes the encrypted contents key Enc (Ku, Kc1) and the meta data MtC1′ to the user data area 4 of the SD card 10 (ST38-s7). In this way, by obtaining the encrypted contents key, purchase processing of step ST38 is completed.

On the other hand, if the encrypted contents key Enc (Ku, Kc1) is already stored in the SD card (ST37; Yes), the control unit 45 reads the encrypted contents key Enc (Ku, Kc1) from the SD card 10 by the SD card processing function 44, and obtains a contents key Kc1 by decrypting the encrypted contents key (ST39). A method for decrypting the encrypted contents key is already explained as steps ST1-ST6. Furthermore, the control unit 45 reads an encrypted contents Enc (Kc1, C1) from the external memory medium 51 via the bus (ST40).

Hereinafter, by executing the start-up software, the control unit 45 decrypts the encrypted contents Enc (Kc1, C1) using the contents key Kc1, and indicates execution of the contents software C1 (ST41). Then, the start-up software is completed and the contents software C1 is executed.

Hereafter, the user terminal 40a executes the contents software C1 until completion of execution of contents is indicated (ST42; No).

In response to an indication of completion of execution of contents, the user terminal 40a updates the meta data MtC1′ and the use history meta data in the SD card 10 (ST43), and completes execution of the contents software C1.

As mentioned-above, in the second embodiment, the external memory medium 51 stores the start-up software. After detecting insertion of the external memory medium 51, the user terminal 40a executes the start-up software stored in the external memory medium 51, decrypts the encrypted contents Enc (Kc1, Cl) using the SD card 10, and obtains the contents software C1. Then, the user terminal 40a completes the start-up software, and executes the contents software C1. In this way, even if the contents software C1 needs the start-up software, the contents software can be utilized based on the encryption double key method.

### The Third Embodiment

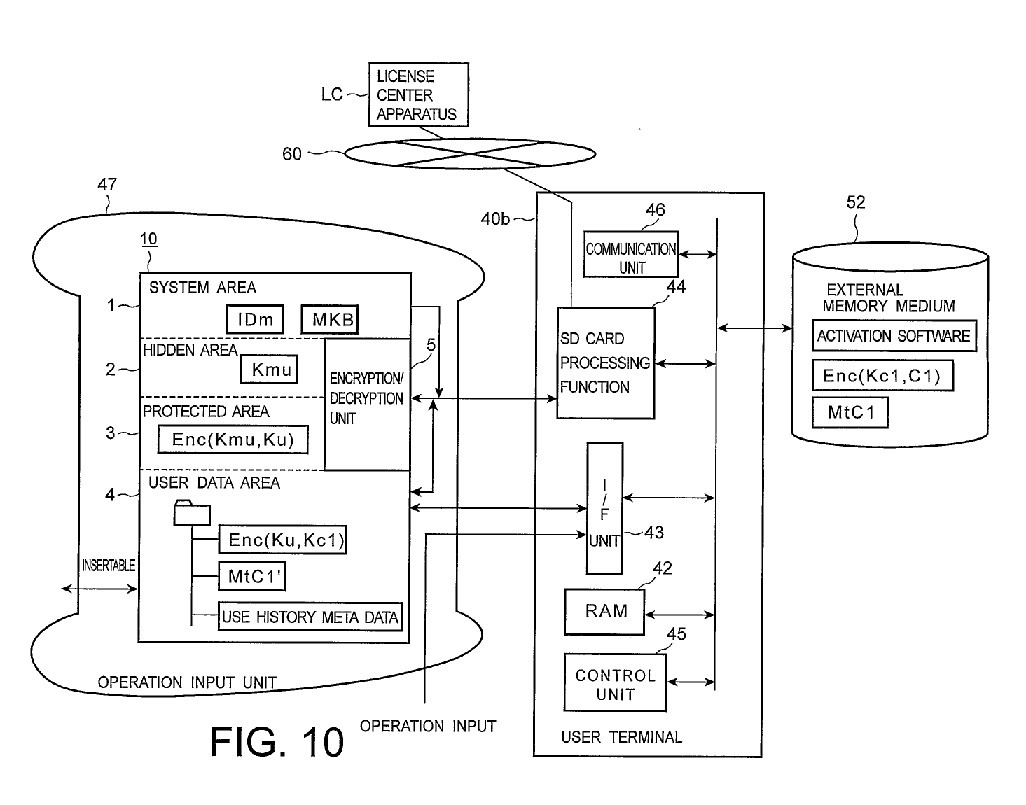

FIG. 10 is a block diagram of a system applied to-the contents use method according to the third embodiment.

The third embodiment is a modification example of the second embodiment, and a form of the external memory medium is different from the second embodiment. In the second embodiment, the external memory medium 51 storing the start-up software is insertable into the user terminal 40a. However, in the third embodiment, an external memory medium 52 storing the start-up software is connected to the user terminal 40b.

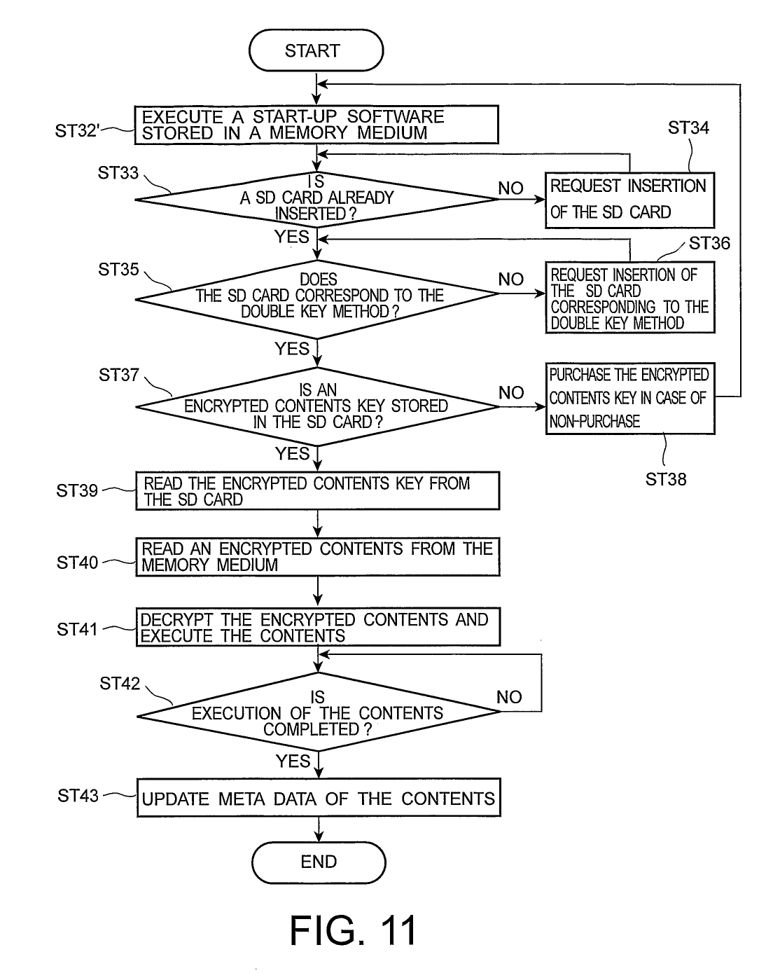

In case of executing the start-up software, as shown in ST32′ of FIG. 11, a user indicates execution of the start-up software to the user terminal 40b through a keyboard (not shown in FIG. 10). In response to the user's indication, the control unit 45 reads the start-up software from the external memory medium 52 to the RAM 42, and executes the start-up software stored in the RAM 42. Processing of steps ST33˜43 is executed in the same way as the second embodiment.

In the third embodiment, by using the external memory medium 52 storing the start-up software, the user terminal 40b reads the start-up software from the external memory medium 52 in response to the user's indication, and executes the start-up software. Accordingly, in the same way as in the second embodiment, the encrypted contents Enc (Kc1, Cl) is decrypted using the SD card, and the contents software C1 is obtained. Then, the user terminal 40b completes the start-up software, and executes the contents software C1. In this way, even if the contents software needs the start-up software, the contents software can be utilized based on the encryption double key method.

### The Fourth Embodiment

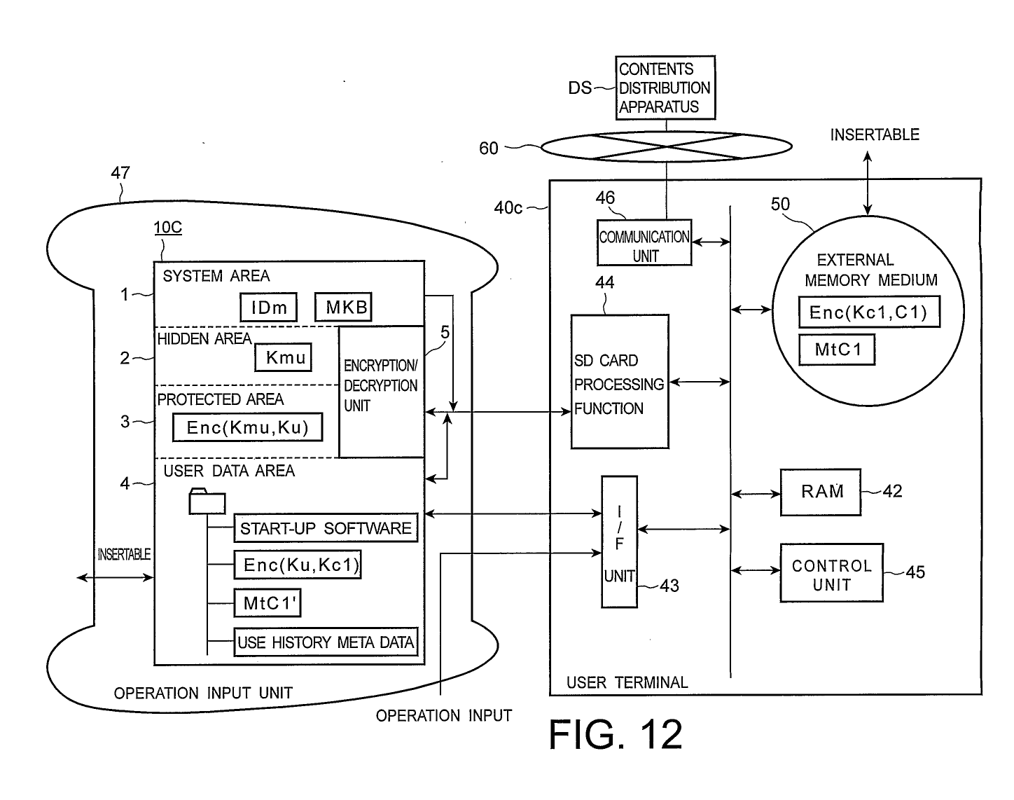

FIG. 12 is a block diagram of a system applied to the contents use method according to the fourth embodiment.

The fourth embodiment is a modification example of the first embodiment, and a part to store the start-up software is different from the first embodiment. In the first embodiment, the start-up software is previously installed into the user terminal 40. However, in the fourth embodiment, the start-up software is stored in the SD card 10c. In comparison with the SD card 10 of the first embodiment, the SD card 10c stores the start-up software in the user data area 4.

In the user terminal 40c of FIG. 12, the start-up software memory 41 of the user terminal 40 of FIG. 2 is omitted. The user terminal 40c includes a function to detect insertion of the SD card, a function to decide whether the SD card is a SD card corresponding to the encryption double key method, and a function to execute the start-up software stored in the SD card if the SD card is a SD card corresponding to the encryption double key method.

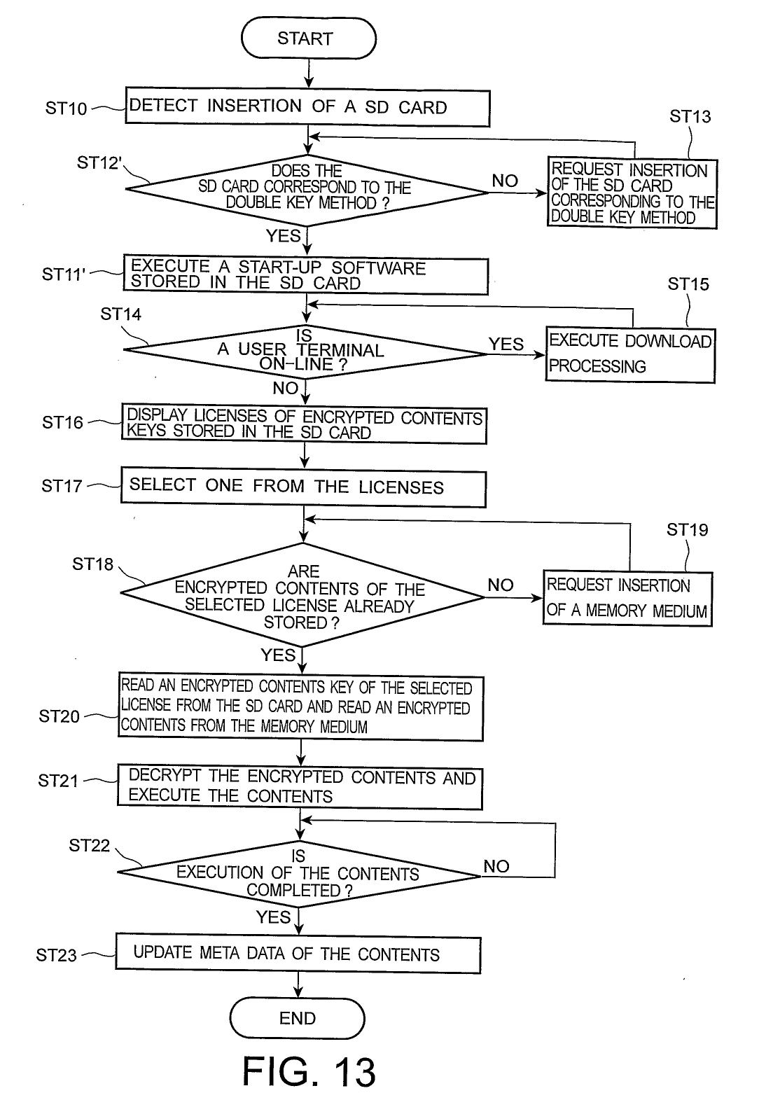

Next, the contents use method applied to the system of FIG. 12 is explained by referring to FIG. 13.

When the SD card 10c is inserted into the operation input unit 47 by a user's operation, the user terminal 40c detects insertion of the SD card 10c (ST10), and decides whether the SD card is a SD card corresponding to the encryption double key method (ST12′). If the SD card is not a SD card corresponding to the encryption double key method (ST12′; No), the user terminal 40c requests insertion of the SD card by outputting a message through the display unit (ST13).

On the other hand, if the SD card is a SD card corresponding to the encryption double key method (ST12′; Yes), the control unit 45 reads the start-up software from the SD card 10c to the RAM 42 by the SD card processing function 44, and executes the start-up software stored in the RAM 42 (ST11′).

Hereinafter, the user terminal 40c executes processing of steps ST14˜23 in the same way as the first embodiment.

In the fourth embodiment, by using the SD card 10c storing the start-up software, the user terminal 40c detects insertion of the SD card 10c, and executes the start-up software stored in the SD card 10c. Accordingly, in the same way as the first embodiment, the encrypted contents Enc (Kc1, C1) is decrypted using the SD card 10c, and the contents software C1 is obtained. Then, the user terminal 40c completes the start-up software, and executes the contents software C1. In this way, even if the contents software C1 needs the start-up software, the contents software can be utilized based on the encryption double key method.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. A method for using a contents software in a user terminal having a key memory medium and a contents memory medium,
the key memory medium storing a medium identifier, a medium inherent key based on the medium identifier, an encrypted user key of a user key based on the medium inherent key, and an encrypted contents key of a contents key based on the user key, and
the contents memory medium storing an encrypted contents software of the contents software based on the contents key,
the method comprising:
executing a start-up software of the contents software;
generating the medium inherent key using the medium identifier;
deriving the user key by decrypting the encrypted user key using the medium inherent key;
deriving the contents key by decrypting the encrypted contents key using the user key; and
deriving the contents software by decrypting the encrypted contents software using the contents key.

2. The method according to claim 1,
wherein the start-up software is stored in the user terminal, and
further comprising:
reading the start-up software from the user terminal in response to a user's operation.

3. The method according to claim 2,
wherein the key memory medium stores licenses corresponding to contents softwares, and
further comprising:
displaying the licenses;
selecting one of the licenses in response to a user's indication; and
reading the encrypted contents software of a contents software corresponding to the one from the contents memory medium.

4. The method according to claim 3,
wherein the key memory medium stores meta data of the contents software, and
further comprising:
updating the meta data in the key memory medium when execution of the contents software is completed.

5. The method according to claim 1,
wherein the start-up software is stored in the contents memory medium, and
further comprising:
reading the start-up software from the contents memory medium by detecting installation of the contents memory medium into the user terminal.

6. The method according to claim 5,
further comprising:
requesting purchase of the encrypted contents key used for the encrypted contents software from a license center apparatus when the key memory medium does not store the encrypted contents key.

7. The method according to claim 6,
wherein the key memory medium stores meta data of the contents software, and
further comprising:
updating the meta data in the key memory medium when execution of the contents software is completed.

8. The method according to claim 1,
wherein the start-up software is stored in the contents memory medium, and
further comprising:
reading the start-up software from the contents memory medium in response to a user's operation.

9. The method according to claim 8,
further comprising:
requesting purchase of the encrypted contents key used for the encrypted contents software from a license center apparatus when the key memory medium does not store the encrypted contents key.

10. The method according to claim 9,
wherein the key memory medium stores meta data of the contents software, and
further comprising:
updating the meta data in the key memory medium when execution of the contents software is completed.

11. The method according to claim 1,
wherein the start-up software is stored in the key memory medium, and
further comprising:
reading the start-up software from the key memory medium by detecting installation of the key memory medium into the user terminal.

12. The method according to claim 11,
wherein the key memory medium stores licenses corresponding to contents softwares, and
further comprising:
displaying the licenses;
selecting one of the licenses in response to a user's indication; and
reading the encrypted contents software of a contents software corresponding to the one from the contents memory medium.

13. The method according to claim 12,
wherein the key memory medium stores meta data of the contents software, and
further comprising:
updating the meta data in the key memory medium when execution of the contents software is completed.

14. A computer program product, comprising:
a computer readable program code embodied in said product for causing a computer to use a contents software in a user terminal having a key memory medium and a contents memory medium,
the key memory medium storing a medium identifier, a medium inherent key based on the medium identifier, an encryption user key of a user key based on the medium inherent key, and an encrypted contents key of a contents key based on the user key, and
the contents memory medium storing an encrypted contents software of the contents software based on the contents key,
said computer readable program code comprising:
a first program code to execute a start-up software of the contents software;
a second program code to generate the medium inherent key using the medium identifier;
a third program code to derive the user key by decrypting the encrypted user key using the medium inherent key;
a fourth program code to derive the contents key by decrypting the encrypted contents key using the user key; and
a fifth program code to derive the contents software by decrypting the encrypted contents software using the contents key.

15. The computer program product according to claim 14,
wherein the start-up software is stored in the user terminal, and
wherein the first program code includes a code to read the start-up software from the user terminal in response to a user's operation.

16. The computer program product according to claim 15,
wherein the key memory medium stores licenses corresponding to contents softwares to be executable, and
wherein the first program code includes a code to display the licenses, a code to select one of the licenses in response to a user's indication, and a code to read the encrypted contents software of a contents software corresponding to the one from the contents memory medium.

17. The computer program product according to claim 16,
wherein the key memory medium stores meta data of the contents software, and
wherein the fifth program code includes a code to update the meta data in the key memory medium when execution of the contents software is completed.

18. The computer program product according to claim 14,
wherein the start-up software is stored in the contents memory medium, and
wherein the first program code includes a code to read the start-up software from the contents memory medium by detecting installation of the contents memory medium into the user terminal.

19. The computer program product according to claim 18,
wherein the fourth program code includes a code to request purchase of the encrypted contents key used for the encrypted contents software from a license center apparatus when the key memory medium does not store the encrypted contents key.

20. The computer program product according to claim 19,
wherein the key memory medium stores meta data of the contents software, and
wherein the fifth program code includes a code to update the meta data in the key memory medium when execution of the contents software is completed.

21. The computer program product according to claim 14,
wherein the start-up software is stored in the contents memory medium, and
wherein the first program code includes a code to read the start-up software from the contents memory medium in response to a user's operation.

22. The computer program product according to claim 21,
wherein the fourth program code includes a code to request purchase of the encrypted contents key used for the encrypted contents software from a license center apparatus when the key memory medium does not store the encrypted contents key.

23. The computer program product according to claim 22,
wherein the key memory medium stores meta data of the contents software, and
wherein the fifth program code includes a code to update the meta data in the key memory medium when execution of the contents software is completed.

24. The computer program product according to claim 14,
wherein the start-up software is stored in the key memory medium, and
wherein the first program code includes a code to read the start-up software from the key memory medium by detecting installation of the key memory medium into the user terminal.

25. The computer program product according to claim 24,
wherein the key memory medium stores licenses corresponding to contents softwares, and
wherein the first program code includes a code to display the licenses, a code to select one of the licenses in response to a user's indication, and a code to read the encrypted contents software of a contents software corresponding to the one from the contents memory medium

26. The computer program product according to claim 25,
wherein the key memory medium stores meta data of the contents software, and
wherein the fifth program code includes a code to update the meta data in the key memory medium when execution of the contents software is completed.

27. A method for using a contents software in a user terminal having a key memory medium, a contents memory medium, and a start-up software of the contents software,
the key memory medium storing a medium identifier, a medium inherent key based on the medium identifier, an encrypted user key of a user key based on the medium inherent key, and an encrypted contents key of a contents key based on the user key, and
the contents memory medium storing an encrypted contents software of the contents software based on the contents key,
the method comprising:
executing the start-up software of the contents software in response to a user's operation;
generating the medium inherent key using the medium identifier;
deriving the user key by decrypting the encrypted user key using the medium inherent key;
deriving the contents key by decrypting the encrypted contents key using the user key; and
deriving the contents software by decrypting the encrypted contents software using the contents key.

28. A method for using a contents software in a user terminal removably having a key memory medium and a contents memory medium,
the key memory medium storing a medium identifier, a medium inherent key based on the medium identifier, an encrypted user key of a user key based on the medium inherent key, and an encrypted contents key of a contents key based on the user key, and
the contents memory medium storing an encrypted contents software of the contents software based on the contents key, and a start-up software of the contents software,
the method comprising:
detecting installation of the contents memory medium into the user terminal;
reading the start-up software from the contents memory medium in response to detection of the installation;
executing the start-up software;
generating the medium inherent key using the medium identifier;
deriving the user key by decrypting the encrypted user key using the medium inherent key;
deriving the contents key by decrypting the encrypted contents key using the user key; and
deriving the contents software by decrypting the encrypted contents software using the contents key.

29. A method for using a contents software in a user terminal removably having a key memory medium and a contents memory medium,
the key memory medium storing a medium identifier, a medium inherent key based on the medium identifier, an encrypted user key of a user key based on the medium inherent key, and an encrypted contents key of a contents key based on the user key, and
the contents memory medium storing an encrypted contents software of the contents software based on the contents key, and a start-up software of the contents software,
the method comprising:
indicating the start-up software in the contents memory medium in response to a user's operation;
reading the start-up software from the contents memory medium;
executing the start-up software;
generating the medium inherent key using the medium identifier;
deriving the user key by decrypting the encrypted user key using the medium inherent key;
deriving the contents key by decrypting the encrypted contents key using the user key; and
deriving the contents software by decrypting the encrypted contents software using the contents key.

30. A method for using a contents software in a user terminal removably having a key memory medium and a contents memory medium,
the key memory medium storing a medium identifier, a medium inherent key based on the medium identifier, an encryption user key of a user key based on the medium inherent key, an encrypted contents key of a contents key based on the user key, and a start-up software of the contents software, and
the contents memory medium storing an encrypted contents software of the contents software based on the contents key,
the method comprising:
detecting installation of the key memory medium into the user terminal;
reading the start-up software from the key memory medium in response to detection of the installation;
executing the start-up software;
generating the medium inherent key using the medium identifier;
deriving the user key by decrypting the encrypted user key using the medium inherent key;
deriving the contents key by decrypting the encrypted contents key using the user key; and
deriving the contents software by decrypting the encrypted contents software using the contents key.

31. A computer program product, comprising:
a computer readable program code embodied in said product for causing a computer to use a contents software in a user terminal having a key memory medium, a contents memory medium, and a start-up software of the contents software,
the key memory medium storing a medium identifier, a medium inherent key based on the medium identifier, an encryption user key of a user key based on the medium inherent key, and an encrypted contents key of a contents key based on the user key, and
the contents memory medium storing an encrypted contents software of the contents software based on the contents key,
said computer readable program code comprising:
a first program code to execute the start-up software of the contents software in response to a user's operation;
a second program code to generate the medium inherent key using the medium identifier;
a third program code to derive the user key by decrypting the encrypted user key using the medium inherent key;
a fourth program code to derive the contents key by decrypting the encrypted contents key using the user key; and
a fifth program code to derive the contents software by decrypting the encrypted contents software using the contents key.

32. A computer program product, comprising:
a computer readable program code embodied in said product for causing a computer to use a contents software in a user terminal removably having a key memory medium and a contents memory medium,
the key memory medium storing a medium identifier, a medium inherent key based on the medium identifier key, an encrypted user key of a user key based the medium inherent key, and an encrypted contents key of a contents key based on the user key, and
the contents memory medium storing an encrypted contents software of the contents software based on the contents key, and a start-up software of the contents software,
said computer readable program code comprising:
a first program code to detect installation of the contents memory medium into the user terminal;
a second program code to read the start-up software from the contents memory medium in response to detection of the installation;
a third program code to execute the start-up software;
a fourth program code to generate the medium inherent key using the medium identifier;
a fifth program code to derive the user key by decrypting the encrypted user key using the medium inherent key;
a sixth program code to derive the contents key by decrypting the encrypted contents key using the user key; and
a seventh program code to derive the contents software by decrypting the encrypted contents software using the contents key.

33. A computer program product, comprising:
a computer readable program code embodied in said product for causing a computer to use a contents software in a user terminal removably having a key memory medium and a contents memory medium,
the key memory medium storing a medium identifier, a medium inherent key based on the medium identifier, an encrypted user key of a user key based on the medium inherent key, and an encrypted contents key of a contents key based on the user key, and
the contents memory medium storing an encrypted contents software of the contents software based on the contents key, and a start-up software of the contents software,
said computer readable program code comprising:
a first program code to indicate the start-up software in the contents memory medium in response to a user's operation;
a second program code to read the start-up software from the contents memory medium;
a third program code to execute the start-up software;
a fourth program code to generate the medium inherent key using the medium identifier;
a fifth program code to derive the user key by decrypting the encrypted user key using the medium inherent key;
a sixth program code to derive the contents key by decrypting the encrypted contents key using the user key; and
a seventh program code to derive the contents software by decrypting the encrypted contents software using the contents key.

34. A computer program product, comprising:
a computer readable program code embodied in said product for causing a computer to use a contents software in a user terminal removably having a key memory medium and a contents memory medium,
the key memory medium storing a medium identifier, a medium inherent key based on the medium identifier, an encrypted user key of a user key based on the medium inherent key, an encrypted contents key of a contents key based on the user key, and a start-up software of the contents software, and
the contents memory medium storing an encrypted contents software of the contents software based on the contents key,
said computer readable program code comprising:
a first program code to detect installation of the key memory medium into the user terminal;
a second program code to read the start-up software from the key memory medium in response to detection of the installation;
a third program code to execute the start-up software;
a fourth program code to generate the medium inherent key using the medium identifier;
a fifth program code to derive the user key by decrypting the encrypted user key using the medium inherent key;
a sixth program code to derive the contents key by decrypting the encrypted contents key using the user key; and
a seventh program code to derive the contents software by decrypting the encrypted contents software using the contents key.
